(19) United States
(12) Patent Application Publication
(10) Pub. No.: US 2026/0064048 A1
(43) Pub. Date: Mar. 5, 2026

(54) FIXING DEVICE AND IMAGE FORMING SYSTEM USING THE SAME

(71) Applicant: FUJIFILM Business Innovation Corp., Tokyo (JP)

(72) Inventors: Mitsuhiro MATSUMOTO, Kanagawa (JP); Satoshi HASEBE, Kanagawa (JP); Toru INOUE, Kanagawa (JP); Kosuke YAMADA, Kanagawa (JP); Daisuke KUWABARA, Kanagawa (JP)

(73) Assignee: FUJIFILM Business Innovation Corp., Tokyo (JP)

(21) Appl. No.: 19/032,529

(22) Filed: Jan. 21, 2025

(30) Foreign Application Priority Data
Sep. 4, 2024 (JP) 2024-152020

(51) Int. Cl. G03G 15/20

(52) U.S. Cl. CPC G03G 15/2017; G03G 15/2064

(57) ABSTRACT

A fixing device includes: a heating fixing unit that is rotatable and includes a heat source; a belt-like transport fixing unit that is rotatably provided as a result of being tightly stretched on the heating fixing unit and that transports a medium having an unfixed image formed thereon while contacting a surface of the medium on which the unfixed image is formed; a pressurizing fixing unit that is rotatable and is disposed to face the heating fixing unit so as to sandwich the transport fixing unit therebetween and that applies pressure so as to form a fixing area between the pressurizing fixing unit and the heating fixing unit, the fixing area being an area where the unfixed image is fixed; a cooling unit that cools the transport fixing unit, the cooling unit being disposed in a transport region of the transport fixing unit for the medium so as to contact a back side of the transport fixing unit, the cooling unit being disposed at a position farther downstream than the fixing area in a transport direction of the medium; and a heat transfer unit that is disposed in an internal space on the back side of the transport fixing unit and is positioned between the cooling unit and the heating fixing unit without contacting the cooling unit and the heating fixing unit and that contacts a first position and a second position and transfers part of heat of the transport fixing unit from the first position to the second position, the first position being located in a region where the transport fixing unit is heated and is not yet cooled, the second position being located in a region where the transport fixing unit is cooled and is not yet heated.

### CROSS-REFERENCE TO RELATED APPLICATIONS

This application is based on and claims priority under 35 USC 119 from Japanese Patent Application No. 2024-152020 filed Sep. 4, 2024.

### BACKGROUND

### (i) Technical Field

The present disclosure relates to a fixing device and an image forming system using the same.

### (ii) Related Art

As an example of a fixing device of the related art, the fixing device disclosed in Japanese Unexamined Patent Application Publication No. 2004-198823 (exemplary embodiment and FIG. 2) is known.

The fixing device disclosed in this publication can perform high quality fixing without causing gloss unevenness due to the occurrence of a blister. This fixing device includes an endless fixing belt, a heating unit, a pressurizing transport belt, and first and second cooling units. The fixing belt rotates in one direction. The heating unit heats the fixing belt. The pressurizing transport belt rotates by a predetermined distance in the same direction as the fixing belt while closely contacting the surface of the fixing belt so as to transport recording paper having a toner image, which is to be fixed, carried thereon by sandwiching the recording paper together with the fixing belt. The first cooling unit cools the recording paper that is brought into close contact with the fixing belt by being pressurized by the pressurizing transport belt. The second cooling unit cools the pressurizing transport belt in a region from when the pressurizing transport belt is separated from the fixing belt until when the pressurizing transport belt contacts the fixing belt again. In this fixing device, the first cooling unit is constituted by a heat circulator and collects heat from the area where the fixing belt contacts the pressurizing transport belt and returns the collected heat to the area where the fixing belt does not contact the pressurizing transport belt nor recording paper.

### SUMMARY

Aspects of non-limiting embodiments of the present disclosure relate to a fixing device and an image forming system using the same in which, at the time of fixing an unfixed image on a medium by heating and cooling a belt-like transport fixing unit, part of heat dissipated from the transport fixing unit during a cooling operation is reused for heating the transport fixing unit so as to reduce energy required for heating and cooling the transport fixing unit.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing device including: a heating fixing unit that is rotatable and includes a heat source; a belt-like transport fixing unit that is rotatably provided as a result of being tightly stretched on the heating fixing unit and that transports a medium having an unfixed image formed thereon while contacting a surface of the medium on which the unfixed image is formed; a pressurizing fixing unit that is rotatable and is disposed to face the heating fixing unit so as to sandwich the transport fixing unit therebetween and that applies pressure so as to form a fixing area between the pressurizing fixing unit and the heating fixing unit, the fixing area being an area where the unfixed image is fixed; a cooling unit that cools the transport fixing unit, the cooling unit being disposed in a transport region of the transport fixing unit for the medium so as to contact a back side of the transport fixing unit, the cooling unit being disposed at a position farther downstream than the fixing area in a transport direction of the medium; and a heat transfer unit that is disposed in an internal space on the back side of the transport fixing unit and is positioned between the cooling unit and the heating fixing unit without contacting the cooling unit and the heating fixing unit and that contacts a first position and a second position and transfers part of heat of the transport fixing unit from the first position to the second position, the first position being located in a region where the transport fixing unit is heated and is not yet cooled, the second position being located in a region where the transport fixing unit is cooled and is not yet heated.

### BRIEF DESCRIPTION OF THE DRAWINGS

Exemplary embodiments of the present disclosure will be described in detail based on the following figures, wherein:

FIG. 1A illustrates an overview of an image forming system including a fixing device that incorporates an exemplary embodiment of the disclosure;

FIG. 1B illustrates a typical mode of a heat transfer unit shown in FIG. 1A;

FIG. 2 illustrates the overall configuration of an image forming system according to a first exemplary embodiment;

FIG. 3A illustrates the major part of a second fixing unit according to the first exemplary embodiment;

FIG. 3B is a sectional view illustrating a transport fixing belt shown in FIG. 3A;

FIG. 4A illustrates a special sheet for a photographic image used as an example of a medium;

FIG. 4B illustrates a state in which a toner image is fixed on the special sheet;

FIG. 4C illustrates a state in which a toner image is fixed on plain paper, which is an example of a medium;

FIG. 5A illustrates a heat transfer instrument used in the first exemplary embodiment;

FIG. 5B illustrates the heat transfer instrument as seen from the direction indicated by the arrow VB in FIG. 5A;

FIG. 5C is a sectional view taken along line VC-VC in FIG. 5A;

FIG. 5D illustrates an example of the configuration of a heat conducting component, which forms the heat transfer instrument;

FIG. 5E schematically illustrates the action of the heat conducting component;

FIG. 6 illustrates a control system of the second fixing unit according to the first exemplary embodiment;

FIG. 7 illustrates an operation of the second fixing unit according to the first exemplary embodiment;

FIG. 8A illustrates a temperature change from the temperature of a transport fixing belt of the second fixing unit which has not yet passed through the heat transfer instrument to the temperature of the transport fixing belt which has passed through the heat transfer instrument;

FIG. 8B illustrates a state in which a medium having passed through the second fixing unit is separated from the transport fixing belt;

FIG. 8C illustrates a state in which a medium having passed through a second fixing unit of a first comparative example is separated from a transport fixing belt;

FIG. 9A illustrates the major part of a second fixing unit according to a second exemplary embodiment;

FIG. 9B illustrates inconvenience which may occur if a holding roller shown in FIG. 9A is not provided;

FIG. 10 illustrates the major part of a second fixing unit according to a modified example of the second exemplary embodiment;

FIG. 11 is a graph illustrating the relationship between the separation temperature of a medium and the gloss of a medium image in a second fixing unit according to a first example;

FIG. 12A is a graph illustrating measurement examples of a first temperature T1 of a transport fixing belt which has passed through a fixing area but has not yet reached a heat transfer instrument and a second temperature T2 of the transport fixing belt which has passed through the heat transfer instrument in a second fixing unit according to a second example; and

FIG. 12B is a graph illustrating examination results concerning the influence of the length of a cooling unit in a cooling area CA in a medium transport direction on the medium separation temperature Ts required for obtaining a high-gloss image in the second fixing unit according to a second example.

### DETAILED DESCRIPTION

### Overview of Exemplary Embodiment

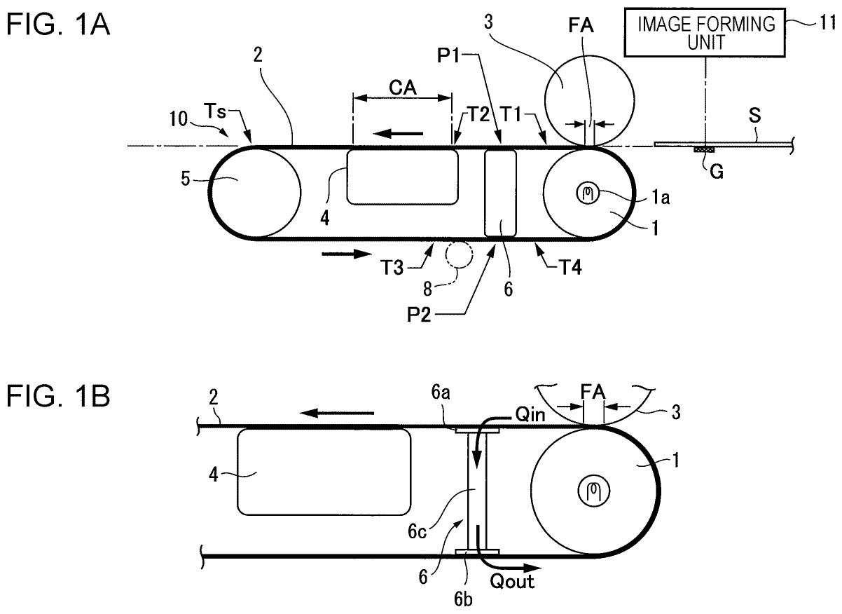

FIG. 1A illustrates an overview of an image forming system including a fixing device which incorporates an exemplary embodiment of the disclosure.

The image forming system shown in FIG. 1A includes an image forming unit 11 and a fixing device 10. The image forming unit 11 forms an image G, which is not yet fixed (hereinafter such an image will be called an unfixed image G), on a medium S. The fixing device 10 fixes the unfixed image G formed on the medium S.

In this example, the fixing device 10 heats and pressurizes the medium S having the unfixed image G held thereon and then cools it so as to fix the unfixed image G onto the medium S. The fixing device 10 includes a heating fixing unit 1, a belt-like transport fixing unit 2, a pressurizing fixing unit 3, a cooling unit 4, and a heat transfer unit 6. The heating fixing unit 1 is rotatable and includes a heat source 1a. The transport fixing unit 2 is rotatably provided as a result of being tightly stretched on the heating fixing unit 1 and transports the medium S while contacting a surface of the medium S on which an image is formed. The pressurizing fixing unit 3 is rotatable and is disposed to face the heating fixing unit 1 so as to sandwich the transport fixing unit 2 therebetween. The pressurizing fixing unit 3 applies pressure so as to form a fixing area FA between the pressurizing fixing unit 3 and the heating fixing unit 1. The cooling unit 4 cools the transport fixing unit 2. The cooling unit 4 is disposed in a transport region of the transport fixing unit 2 for the medium S so as to contact the back side of the transport fixing unit 2. The cooling unit 4 is located at a position farther downstream than the fixing area FA in the transport direction of the medium S. The heat transfer unit 6 is disposed in the internal space on the back side of the transport fixing unit 2 and between the cooling unit 4 and the heating fixing unit 1 without contacting them. The heat transfer unit 6 contacts a first position P1 and a second position P2 and transfers part of heat of the transport fixing unit 2 from the first position P1 to the second position P2. The first position P1 is located in a region where the transport fixing unit 2 is heated and is not yet cooled. The second position P2 is located in a region where the transport fixing unit 2 is cooled and is not yet heated.

In this example, the transport fixing unit 2 is tightly stretched on the heating fixing unit 1 and a separator 5, as illustrated in FIG. 1A. The separator 5 is located farther downstream than the cooling unit 4 in the transport direction of the medium S and is disposed at a position at which it separates the medium S from the transport fixing unit 2. The transport fixing unit 2 may be provided in a different manner from that illustrated in FIG. 1A. For example, another member, which is not shown, may be added to tightly support the transport fixing unit 2.

The fixing device 10 of the exemplary embodiment configured as described above may be built in an image forming apparatus including the image forming unit 11 that forms the unfixed image G. Alternatively, the fixing device 10 may be built in a postprocessing device, which is different from an image forming apparatus, and may be formed as an image forming system including multiple units.

The heating fixing unit 1 includes a heating fixing roller, for example. The heat source 1a may be built in the heating fixing unit 1 or may be externally provided. The transport fixing unit 2 includes a belt-like member. The belt-like member may be constituted by an endless film made of a thermosetting polyimide resin. In order to obtain a high-gloss image, such as a photographic image, a highly smooth coating layer may be applied onto the surface of the endless film. The pressurizing fixing unit 3 may have a desired shape such as a roller-like shape or a belt-like shape as long as it can pressurize the medium S so as to form the fixing area FA between the pressurizing fixing unit 3 and the heating fixing unit 1. If necessary, the pressurizing fixing unit 3 may include a heat source, which is not shown.

A wide range of devices can be used for the cooling unit 4 if they can cool the transport fixing unit 2 by contacting the back side of the transport fixing unit 2 within a medium transport area. One of the major examples of the cooling unit 4 is a heat dissipating unit that dissipates absorbed heat, such as a heat sink.

In this example, the heat transfer unit 6 may be installed at any position if it is disposed between the cooling unit 4 and the heating fixing unit 1. One of the major functions of the heat transfer unit 6 is to transfer heat of the transport fixing unit 2 from the first position P1 to the second position P2. To implement this function, the heat transfer unit 6 is disposed not to contact the cooling unit 4 and the heating fixing unit 1.

It may not be necessary that the entirety of the heat transfer unit 6 is disposed between the cooling unit 4 and the heating fixing unit 1. Instead, for example, the heat transfer unit 6 may be disposed to contact the transport fixing unit 2 by partially extending to a space between the cooling unit 4 and the transport fixing unit 2.

The first position P1 is located in the medium transport area of the transport fixing unit 2 and, more specifically, it is located in a region where the transport fixing unit 2 has passed through the fixing area FA and has not yet reached a cooling area CA of the cooling unit 4.

The second position P2 is typically located between the cooling unit 4 and the heating fixing unit 1. However, if part of the heat transfer unit 6 extends to a space between the cooling unit 4 and the transport fixing unit 2, the second position P2 may be set at an exceptional position. In this case, the second position P2 may be set in a space between the cooling unit 4 and the transport fixing unit 2 or at a position beyond this space. It is not desirable, however, that the second position P2 be located in a region from the position at which the transport fixing unit 2 is cooled by the cooling unit 4 to the position at which the medium S is separated. If the second position P2 is located in such a region, the medium S is heated before it is separated. In this example, therefore, the second position P2 is determined to be a position farther downstream than the separation position of the medium S in the moving direction of the transport fixing unit 2.

In this example, the heat transfer unit 6 typically includes a heat conducting component 6c that conducts heat from a high temperature portion to a low temperature portion of the transport fixing unit 2. A typical example of the heat conducting component 6c is a heat pipe, but the heat conducting component 6c is not limited thereto. Another suitable component may be selected. The heat conducting component 6c of the heat transfer unit 6 is disposed to directly or indirectly contact the transport fixing unit 2 between the high temperature portion and the low temperature portion of the transport fixing unit 2. In this case, heat at the high temperature portion and that at the low temperature portion may be transferred substantially equally therebetween in a direction intersecting with the transport direction of the medium S.

In one example, as illustrated in FIG. 1B, the heat transfer unit 6 includes a first contact member 6a, a second contact member 6b, and the heat conducting component 6c. In this example, the first contact member 6a is disposed to contact the first position P1 on the back side of the transport fixing unit 2. The first contact member 6a is made of a heat conducting material and extends in a direction intersecting with the moving direction of the transport fixing unit 2. The second contact member 6b is disposed to contact the second position P2 on the back side of the transport fixing unit 2. The second contact member 6b is made of a heat conducting material and extends in the direction intersecting with the moving direction of the transport fixing unit 2. One or multiple heat conducting components 6c are used and are bonded between the first contact member 6a and the second contact member 6b.

To stably exert the heat transfer function of the heat transfer unit 6, it may be desirable to maintain the good contact state between the heat transfer unit 6 and the transport fixing unit 2. In this case, as indicated by the long dashed double-dotted line in FIG. 1A, a holding unit 8 is provided to maintain the contact state between the heat transfer unit 6 and the transport fixing unit 2. The holding unit 8 is disposed farther upstream than the second position P2 of the transport fixing unit 2 in the moving direction of the transport fixing unit 2, for example. The holding unit 8 serves as a positioning unit that determines the position of the transport fixing unit 2 so that the heat transfer unit 6 can maintain the good contact state with the second position P2.

In this example, the medium S is separated at a separation position at the separator 5. The separation position is a position at which the traveling path of the transport fixing unit 2 tightly stretched on the separator 5 is changed from a straight line to a curved line. By setting a separation temperature Ts of the medium S to a predetermined threshold or lower, a high-gloss image can be obtained as a fixed image on the medium S. To obtain a high-gloss image, in this example, the heat transfer unit 6 may have heat conductivity that allows the separation temperature Ts of the medium S to become lower than or equal to the threshold. In this case, the heat conductivity of the heat transfer unit 6 is determined based on the heating amount of the heating fixing unit 1 and the heat dissipation amount of the cooling unit 4.

The operation of the fixing device 10 according to the exemplary embodiment will now be described below.

In this example, the medium S passes through the fixing area FA of the fixing device 10. When the medium S passes through the fixing area FA, the unfixed image G on the medium S is heated and pressurized by the heating fixing unit 1 and the pressurizing fixing unit 3 so as to be fixed onto the medium S.

After passing through the fixing area FA, the medium S is transported by the transport fixing unit 2. While being transported, the medium S is cooled by the cooling unit 4 and is then separated from the transport fixing unit 2 by the separator 5 at the separation position. In this manner, in this example, the unfixed image G on the medium S is subjected to a series of fixing processing, such as heating and pressurizing processing and then cooling processing.

As the medium S, a special sheet suitable to obtain a high-gloss image is used. As a result of the unfixed image G undergoing the above-described series of fixing processing, a high-gloss image can be obtained.

In this example, the heat transfer unit 6 is provided between the first position P1 and the second position P2 of the transport fixing unit 2. The first position P1 is a high temperature portion in which the transport fixing unit 2 has been heated by the heating fixing unit 1, while the second position P2 is a low temperature portion in which the transport fixing unit 2 has been cooled by the cooling unit 4. Hence, heat is transferred through the heat transfer unit 6 from the first position P1, which is the high temperature portion, to the second position P2, which is the low temperature portion. In this heat transfer process, heat Qin is absorbed from the transport fixing unit 2 to the heat transfer unit 6 at the first position P1, while heat Qout is dissipated from the heat transfer unit 6 to the transport fixing unit 2 at the second position P2. The dissipated heat Qout is substantially equivalent to the absorbed heat Qin.

The temperature of the transport fixing unit 2 at a position before the first position P1 and that at a position after the first position P1 are indicated by T1 and T2, respectively. The temperature T2 of the transport fixing unit 2 becomes lower than the temperature T1. Thanks to the heat transfer unit 6, the transport fixing unit 2 can enter the cooling area CA of the cooling unit 4 at the temperature T2, which is lower than the temperature if the heat transfer unit 6 were not provided. As a result, the cooling unit 4 requires less energy to cool the transport fixing unit 2 than that without the heat transfer unit 6.

The temperature of the transport fixing unit 2 at a position before the second position P2 and that at a position after the second position P2 are indicated by T3 and T4, respectively. The temperature T4 of the transport fixing unit 2 becomes higher than the temperature T3. Thanks to the heat transfer unit 6, the transport fixing unit 2 can return to a heating area of the heating fixing unit 1 at the temperature T4, which is higher than that if the heat transfer unit 6 were not provided. As a result, the heating fixing unit 1 requires less energy to heat the transport fixing unit 2 than that without the heat transfer unit 6.

Typical exemplary embodiments and other exemplary embodiments of the fixing device based on the above-described exemplary embodiment will now be described below with reference to the accompanying drawings.

### First Exemplary Embodiment

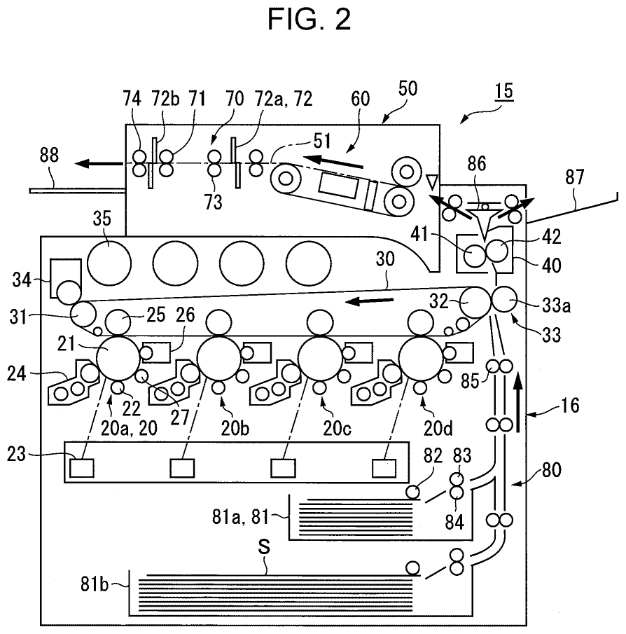

FIG. 2 illustrates the overall configuration of an image forming system according to a first exemplary embodiment.

### Overall Configuration of Image Forming System

In FIG. 2, an image forming system 15 includes a device body 16 containing an image forming unit that can form color images. A postprocessing device 50, which is an optional device, is additionally provided on the top of the device body 16. Multiple medium supply containers 81 (81a, 81b) that supply a medium, such as sheets, are provided in the bottom side of the device body 16 so as to be pulled out of the device body 16.

### Image Forming Unit

An image forming unit used in the first exemplary embodiment utilizes an electrophotographic system, for example, and includes multiple image formers 20. The image formers 20 form four colors of images (yellow (Y), magenta (M), cyan (C), and black (K)), for example. In this example, the image formers 20 (20a through 20d) are arranged side by side along a belt-like intermediate transfer body 30, that is, they are formed in what is known as a tandem structure. For example, multiple colors of toner images formed by the individual image formers 20 (20a through 20d) are sequentially transferred onto the intermediate transfer body 30 (this is called a first transfer operation) and are superimposed on each other. After the superimposed toner images are transferred together onto a medium S transported from the medium supply container 81, they are fixed on the medium S. The image formers 20 may not necessarily be arranged in order of Y, M, C, and K, and may be arranged in a different order.

### Image Former

The image formers 20 (20a through 20d) in the first exemplary embodiment each include a photoconductor 21, which serves as an image carrier that forms and carries a toner image of a corresponding color component. Around the photoconductor 21, a charger 22, an exposure device 23, a developing device 24, a first transfer device 25, a photoconductor cleaner 26, and a static eliminator 27, for example, are disposed. The charger 22 is constituted by a charging roller, for example, that charges the photoconductor 21. The exposure device 23 is constituted by a laser scanner or a light emitting diode (LED) array, for example, that forms an electrostatic latent image on the photoconductor 21 charged by the charger 22. The developing device 24 includes a developing roller, for example, which develops an electrostatic latent image formed on the photoconductor 21 by using a toner of a corresponding color. The first transfer device 25 is disposed at a position at which it faces the photoconductor 21 so as to sandwich the intermediate transfer body 30 therebetween. The first transfer device 25 is constituted by a first transfer roller or a corona discharger, for example, that performs the first transfer operation for transferring a toner image on the photoconductor 21 to the intermediate transfer body 30. The photoconductor cleaner 26 includes a cleaning member for cleaning residual toner remaining on the photoconductor 21. The static eliminator 27 is constituted by a static eliminator roller or a corona discharger, for example, for eliminating residual electric charge remaining on the photoconductor 21.

In the first exemplary embodiment, the single exposure device 23 performs an exposure operation for the four image formers 20 (20a through 20d).

### Intermediate Transfer Body and Second Transfer Device

The intermediate transfer body 30 is tightly stretched on multiple tension rollers 31 and 32. For example, the tension roller 31 serves as a driving roller, which transports the intermediate transfer body 30. The tension roller 32 serves as a backup roller for a second transfer device 33, for example, and is located to face the second transfer device 33. An intermediate transfer body cleaner 34, which removes residual toner on the intermediate transfer body 30, is also disposed at a position at which it faces the tension roller 31 used for the intermediate transfer body 30.

In this example, the second transfer device 33 includes a second transfer roller 33a that contacts the front side of the intermediate transfer body 30 which faces the tension roller 32. In this example, the second transfer device 33 applies a second transfer electric field to between the second transfer roller 33a and the tension roller 32 so as to transfer images on the intermediate transfer body 30 together onto the medium S (this is called a second transfer operation).

Inside the device body 16, toner boxes 35 are provided above the intermediate transfer body 30 so as to correspond to the developing devices 24 of the individual image formers 20. The individual toner boxes 35 supply toner to the developing devices 24 of the corresponding colors via a transport path, which is not shown.

### Medium Transport System

A medium transport system 80 in the first exemplary embodiment is formed as follows. A medium is fed from each medium supply container 81 by a pickup roller 82. Then, the medium is sorted by a feed roller 83 and a retard roller 84 and only one sheet of medium is transported to the transport path on the downstream side. In the transport path, matching rollers 85 and a first fixing unit 40 are provided. The matching rollers 85 determine the position of the medium S carried from the medium supply container 81 before the medium S enters the second transfer device 33. The first fixing unit 40 fixes an unfixed toner image transferred onto the medium S by the second transfer device 33. A switching member 86, which switches the transport path, is provided on the downstream side of the first fixing unit 40. In this example, the switching member 86 switches the transport path between two directions, which are toward the postprocessing device 50 and toward a first output receiver 87. The first output receiver 87 stores a medium directly output from the device body 16.

As the medium supply container 81, two medium supply containers 81a and 81b that store different sizes of sheets of medium are shown by way of example. However, this is only an example, and three or more medium supply containers 81 may be provided, or only one medium supply container 81 may be provided. A manual feeder, which is not shown, may be provided, and a medium may be fed from the manual feeder to the transport path.

### First Fixing Unit

The first fixing unit 40 in the first exemplary embodiment includes a heating fixing roller 41 and a pressurizing fixing roller 42, for example. The heating fixing roller 41 has a built-in heat source, such as a halogen lamp, which is not shown. The pressurizing fixing roller 42 is disposed to face the heating fixing roller 41 and transports a medium by sandwiching it to a fixing area formed between the pressurizing fixing roller 42 and the heating fixing roller 41. With this configuration, when a medium having an unfixed toner image held thereon passes through the fixing area of the first fixing unit 40, the unfixed toner image is fixed onto the medium by the application of heat and pressure.

In this example, a pair of a heating roller and a pressurizing roller is used for the first fixing unit 40. However, the first fixing unit 40 is not limited to this configuration, and suitable members can be selected. For example, a medium may be held in a fixing area formed between a heating fixing roller and a pressurizing fixing belt, and an unfixed image on the medium may be fixed by the application of heat and pressure. In this case, a pressurizing pad is provided to face the heating fixing roller, and the pressurizing fixing belt is interposed between the heating fixing roller and the pressurizing pad. In this example, the pressurizing fixing belt is rotated by the rotation of the heating fixing roller.

### Configuration Example of Postprocessing Device

As illustrated in FIG. 2, the postprocessing device 50 includes a second fixing unit 60 and a cutting device 70. The second fixing unit 60 is provided in a mid-portion of a medium transport path 51 and processes a toner image surface of a medium into a high-gloss surface. The cutting device 70 cuts a medium having passed through the second fixing unit 60. In the first exemplary embodiment, a second output receiver 88 is provided on the downstream side of the postprocessing device 50 and stores a medium having passed through the cutting device 70.

Before giving a detailed explanation of the second fixing unit 60, the cutting device 70 will first be explained below.

### Cutting Device

In the first exemplary embodiment, the cutting device 70 can cut sides of a medium and form a borderless print sheet, for example. To implement this purpose, as shown in FIG. 2, the cutting device 70 includes a slitter 71 and circular cutters 72 (72a, 72b). The slitter 71 is a member which cuts a medium along the width, while the circular cutter 72 is a member which cuts the medium along the length in the feeding direction. The cutting device 70 also includes multiple transport rollers 73 and 74 to transport a medium.

In this example, the slitter 71 has a required number of blades in the axial direction in accordance with the number of pieces to be produced by cutting a medium and cuts the medium in the feeding direction while transporting it. The circular cutter 72 temporarily stops the transportation of a medium and then cuts the medium by moving a rolling cutter having an upper blade along a lower blade. As the circular cutter 72, a roller cutter may be provided in the axial direction and cut a medium while transporting it.

The cutting device 70 has, not only a function of cutting a medium into multiple (four, for example) pieces, but also other functions. As an example of the other functions of the cutting device 70, one L-size (standard photo size in Japan, which is equivalent to 3R size (standard photo size in the United States)) image is printed on a postcard-size medium (100×150 mm), and the cutting device 70 can finish the medium as a borderless print sheet. As another example of the other functions of the cutting device 70, a desired number of L-size (3R-size) images, such as photographic images using a digital camera, can be obtained. For example, four images are printed on an A4-size medium, and then, the four images are printed one by one on a desired number of postcard-size mediums. Additionally, as a result of varying the widthwise position of the blades of the slitter 71, a medium can be cut into various sizes, such as into four pieces, six pieces, and eight pieces.

### Basic Configuration of Second Fixing Unit

The basic configuration of the second fixing unit 60 is similar to that of the fixing device 10 shown in FIG. 1A.

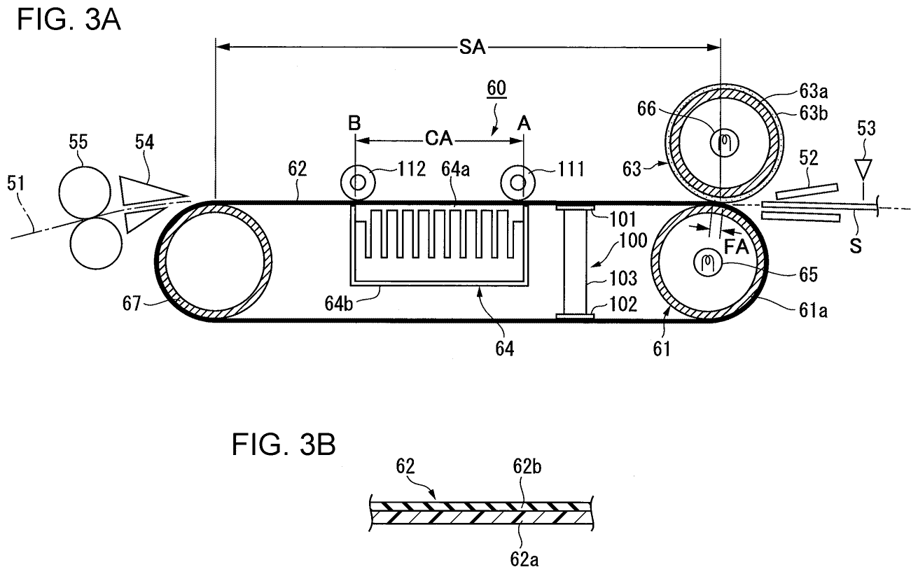

That is, as illustrated in FIGS. 2 and 3A, the second fixing unit 60 includes a heating fixing roller 61, a transport fixing belt 62, a pressurizing fixing roller 63, and a cooling unit 64.

The heating fixing roller 61, which corresponds to the above-described heating fixing unit (see FIG. 1A), includes a built-in heat source 65 in this example. The transport fixing belt 62, which corresponds to the above-described transport fixing unit (see FIG. 1A), is rotatably provided as a result of being tightly stretched on the heating fixing roller 61. The transport fixing belt 62 transports the medium S while contacting the surface of the medium S on which an image is formed. The pressurizing fixing roller 63, which corresponds to the above-described pressurizing fixing unit (see FIG. 1A), is disposed to face the heating fixing roller 61 so as to sandwich the transport fixing belt 62 therebetween. The pressurizing fixing roller 63 is pressed against the heating fixing roller 61 so as to form a fixing area FA therebetween.

The cooling unit 64, which corresponds to the above-described cooling unit (see FIG. 1A), is disposed in a space surrounded by the transport fixing belt 62 and cools the transport fixing belt 62. In this example, the cooling unit 64 is located farther downstream than the fixing area FA in the transport direction of the medium S and is disposed to contact the back side of the transport fixing belt 62 within a medium transport area SA.

### Heating Fixing Roller

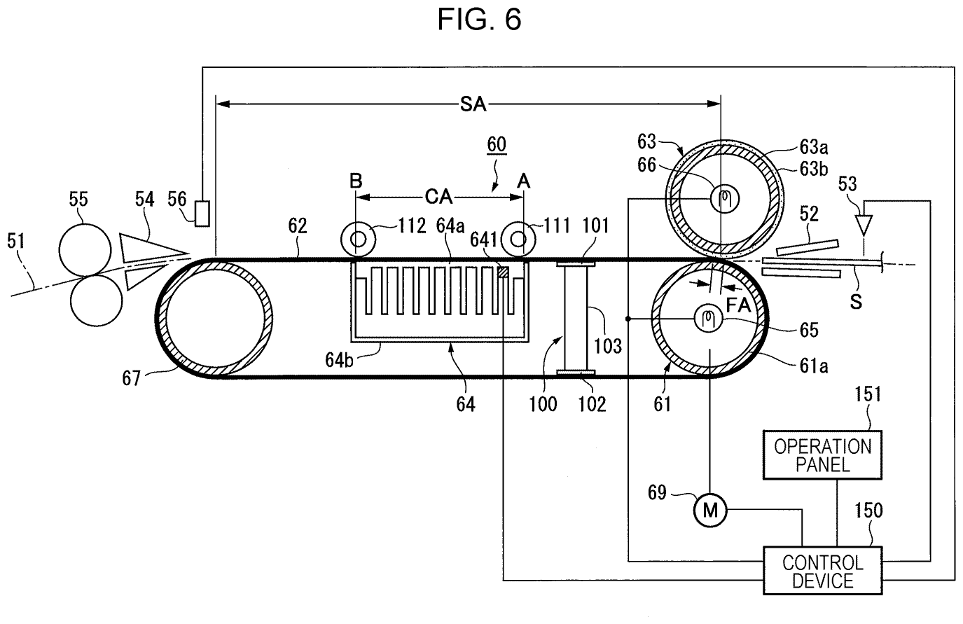

The heating fixing roller 61 is formed by applying a release layer (not shown) constituted by a PFA tube, for example, onto the surface of a metal core 61a having high heat conductivity. A heat source 65, such as a halogen lamp, is provided inside the core 61a. Heating of the heat source 65 is controlled so that the surface of the heating fixing roller 61 has a predetermined temperature. The heating fixing roller 61 is driven to rotate by a drive motor 69 (see FIG. 6) so as to rotate the transport fixing belt 62.

### Transport Fixing Belt

As illustrated in FIG. 3B, the transport fixing belt 62 is constituted by an endless film base member 62a made of a thermosetting polyimide resin, for example, coated with a highly smooth coating layer 62b made of fluorine rubber or silicone rubber, for example. As the film base member 62a and the coating layer 62b of the transport fixing belt 62, a base member and a coating layer each having a suitable thickness are selected to maintain the mechanical strength and to efficiently utilize thermal energy. For example, a base member having a thickness of about 75 μm coated with a coating layer having a thickness of about 35 μm is used.

The transport fixing belt 62 is tightly stretched on the heating fixing roller 61 and a separating roller 67 so as to be rotated by the rotation of the heating fixing roller 61.

The separating roller 67 corresponds to the above-described separator (see FIG. 1A) and separates the medium S from the transport fixing belt 62. The separating roller 67 is rotated by following the movement of the transport fixing belt 62. The separating roller 67 tightly supports the transport fixing belt 62 thereon while winding it up so as to cause a sudden change in the moving direction of the transport fixing belt 62. Because of this configuration, at the position of the separating roller 67, the medium S on the transport fixing belt 62 is separated from the transport fixing belt 62 by itself because of the stiffness of the medium S.

The transport fixing belt 62 is tightly stretched on the heating fixing roller 61 and the separating roller 67 in this example. However, the transport fixing belt 62 may be provided in a different manner. For example, a steering roller, which is not shown, may be provided in a region where the transport fixing belt 62 returns from the separating roller 67 to the heating fixing roller 61. In this case, the steering roller presses the transport fixing belt 62 outwardly to maintain the tension of the transport fixing belt 62. The steering roller tilts the rotating axis of oneself to correct the position of the transport fixing belt 62 which is displaced to one side while rotating. The displacement of the transport fixing belt 62 to one side refers to that the transport fixing belt 62 is shifted toward one of the two ends in a direction of the rotating axis of the steering roller.

### Pressurizing Fixing Roller

The pressurizing fixing roller 63 is formed such that an elastic layer 63b made of silicone rubber, for example, covers the surface of a metal core 63a having high heat conductivity. A release layer (not shown) similar to that of the heating fixing roller 61 is formed on the surface of the elastic layer 63b. In the first exemplary embodiment, a heat source 66, such as a halogen lamp, is provided inside the core 63a of the pressurizing fixing roller 63. Heating of the heat source 66 is controlled so that the surface of the pressurizing fixing roller 63 has a predetermined temperature. The medium S transported to the second fixing unit 60 passes through the fixing area FA formed between the heating fixing roller 61 and the pressurizing fixing roller 63. At this time, a toner image on the medium S is heated and pressurized in a state in which the toner image surface of the medium S contacts the transport fixing belt 62.

### Cooling Unit

In the first exemplary embodiment, the cooling unit 64 is provided in a region between the heating fixing roller 61 and the separating roller 67 (this region corresponds to the medium transport area SA) in a state in which it contacts the back side of the transport fixing belt 62. The cooling unit 64 contacts a portion of the medium transport area SA of the transport fixing belt 62 and uses this contact portion as the cooling area CA. In the cooling area CA, the cooling unit 64 cools the transport fixing belt 62 by absorbing heat of the transport fixing belt 62. With this configuration, the medium S, which is transported while closely contacting the transport fixing belt 62, can be cooled.

The cooling unit 64 in the first exemplary embodiment corresponds to a heat sink and includes a fin member 64a and a cover member 64b. The fin member 64a includes many heat dissipating fins extending substantially perpendicular to the surface of the transport fixing belt 62. The cover member 64b is formed in a tubular shape having a rectangular cross section so as to cover the fin member 64a. The cooling unit 64 uses an air blower, which is not shown, to cause air to flow inside, thereby dissipating heat in the fin member 64a to the outside.

A temperature sensor 641 (see FIG. 6) is disposed on part of the fin member 64a, for example. The cooling unit 64 turns the air blower ON or OFF or controls the air volume of the air blower, based on a detection result of the temperature sensor 641.

### Close-Contact Transportation of Medium

In the first exemplary embodiment, in terms of securing the cooling effect of the cooling unit 64, the cooling unit 64 is formed as shown in FIG. 3A. That is, in this example, the medium S can be located to closely contact the cooling area CA of the cooling unit 64 while being transported by the transport fixing belt 62.

In this example, an inlet opposing roller 111 is provided on the front side of the transport fixing belt 62 at a portion corresponding to the inlet (upstream start point A) of the cooling area CA of the cooling unit 64. The inlet opposing roller 111 is disposed to contact the transport fixing belt 62 and is rotated by following the movement of the transport fixing belt 62.

An outlet opposing roller 112 is provided on the front side of the transport fixing belt 62 at a portion corresponding to the outlet (downstream end point B) of the cooling area CA of the cooling unit 64. The outlet opposing roller 112 is disposed to contact the transport fixing belt 62 and is rotated by following the movement of the transport fixing belt 62.

In this manner, each of the inlet opposing roller 111 and the outlet opposing roller 112 serves as an opposing rotator.

In this example, the inlet opposing roller 111 is located at a portion corresponding to the inlet of the cooling area CA. By positioning the inlet opposing roller 111 at this portion, the medium S transported by the transport fixing belt 62 is pulled in at the inlet of the cooling area CA so as to closely contact the transport fixing belt 62.

The provision of the outlet opposing roller 112 is effective in closely contacting the medium S to the transport fixing belt 62. More specifically, the outlet opposing roller 112 serves to closely contact the medium S to the transport fixing belt 62, together with the inlet opposing roller 111, at two leading and trailing locations in the transport direction of the medium S. The outlet opposing roller 112 is disposed at a portion corresponding to the outlet of the cooling area CA. However, the position of the outlet opposing roller 112 is not limited to this portion and may be provided farther upstream than the outlet of the cooling area CA.

### Selection of Medium

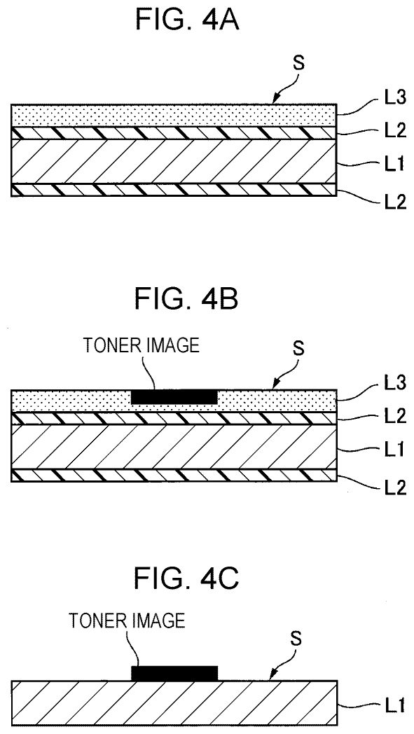

Typically, to obtain a high-gloss image, such as a photographic image, a special sheet, such as that shown in FIG. 4A, may be used as the medium S. In this special sheet, a moisture-proof layer L2 is applied onto each side of a base member layer L1, and an image receiving layer L3 is provided on a recording surface (surface on which a toner image is to be formed) of the moisture-proof layer L2. This structure is similar to that of photographic paper used for a silver halide print, for example.

The moisture-proof layer L2 is made of a resin having no permeability, such as polyethylene, and has a thickness of about several micrometers to exhibit a moisture-proof effect for the base member layer L1. The image receiving layer L3 is made of a thermosetting resin, as a principal component, such as polyester, having a melting temperature of about 130° C. and has a thickness of 5 to 20 μm, and more preferably, about 10 μm. The base member layer L1 has a composition similar to that of plain paper, which is made of cellulose as a principal component. Alternatively, a special base member layer L1 having a composition different from that of plain paper may be used.

As the medium S, therefore, a medium having a moisture-proof layer L2 on each side of a base member layer L1 and having an image receiving layer L3 made of a material similar to a toner material on the recording surface of the moisture-proof layer L2 may be selected.

In a photograph print mode, if the second fixing unit 60 performs a fixing operation using such a special sheet, the resulting toner image is embedded into the image receiving layer L3, as shown in FIG. 4B. At this time, the surface texture of the transport fixing belt 62 of the second fixing unit 60 is reflected, which makes the surface of the image receiving layer L3 and the surface of the toner image substantially uniform, resulting in a high-gloss image. In contrast, in a plain paper print mode, a toner image is fixed on plain paper used as the medium S only with the first fixing unit 40. In this case, as shown in FIG. 4C, the toner image is merely mounted on the base member layer L1 and is projected from the surface of the base member layer L1, resulting in an image having poor gloss characteristics.

### Distinctive Configuration of Second Fixing Unit

In this example, as illustrated in FIG. 3A, the second fixing unit 60 includes a heat transfer instrument 100 in a space surrounded by the transport fixing belt 62. The heat transfer instrument 100 transfers part of heat in a high temperature portion of the transport fixing belt 62 to a low temperature portion thereof. The high temperature portion is a portion of the transport fixing belt 62 positioned on the farther downstream side than the fixing area FA in the moving direction of the transport fixing belt 62 until the upstream start point A of the cooling area CA. The low temperature portion is a portion of the transport fixing belt 62 positioned on the farther downstream side than the separating roller 67 in the moving direction of the transport fixing belt 62 until the start point of the heating area of the heating fixing roller 61.

### Necessity of Providing Heat Transfer Instrument

It is now assumed that the heat transfer instrument 100 is not provided, in which case, the fixing operation is performed as follows. The second fixing unit 60 heats the transport fixing belt 62 by using the heating fixing roller 61 and fixes a toner image onto the medium S by the application of heat and pressure in the fixing area FA. Then, to obtain a high-gloss image, the second fixing unit 60 cools the medium S on the transport fixing belt 62 to a predetermined temperature by using the cooling unit 64.

In this manner, heating and cooling (heat dissipation) are repeatedly performed while the transport fixing belt 62 is rotated between the heating fixing roller 61 and the separating roller 67. The cooling capacity of the cooling unit 64 is determined by the temperature of the transport fixing belt 62 which is just about to enter the cooling area CA. Heating energy required for the heating fixing roller 61 is determined by the temperature of the transport fixing belt 62 which is just about to enter the heating area after it is cooled by the cooling unit 64.

In such a heating and cooling cycle, heat received from the transport fixing belt 62 to lower the temperature of the transport fixing belt 62 in the cooling operation is discarded and is wasted. The heating fixing roller 61 requires heating energy to raise the temperature of the transport fixing belt 62 cooled by the cooling unit 64 to a temperature high enough to fix a toner image on a medium. Without the heat transfer instrument 100, a sufficient level of the cooling capacity of the cooling unit 64 is necessary. To meet this demand, it is difficult to reduce the size of the cooling unit 64. A sufficient amount of energy for heating the transport fixing belt 62 is also required, and to meet this demand, it is difficult to reduce the amount of heating energy of the heating fixing roller 61.

To address the above-described issue, this example intends to lower the energy dissipated by the cooling unit 64 and to reduce the amount of heating energy required for the heating fixing roller 61.

### Installation Position of Heat Transfer Instrument

In this example, as illustrated in FIG. 3A, the heat transfer instrument 100 is disposed in the internal space on the back side of the transport fixing belt 62. The heat transfer instrument 100 is located between the cooling unit 64 and the heating fixing roller 61 without contacting them. The heat transfer instrument 100 in this example serves to transfer part of heat of the transport fixing belt 62 from a first position P1 to a second position P2.

As the first position P1, a position in a high temperature region where the transport fixing belt 62 is heated by the heating fixing roller 61 and is not yet cooled by the cooling unit 64 is selected. As the second position P2, a position on the farther downstream side than the separating roller 67 in the moving direction and in a low temperature region where the transport fixing belt 62 has not yet entered the heating area of the heating fixing roller 61 is selected. As the second position P2, a position within the medium transport area SA after the transport fixing belt 62 is cooled by the cooling unit 64 or the area where the transport fixing belt 62 is located on the separating roller 67 is not desirable. This is because the transport fixing belt 62 and the medium S cooled by the cooling unit 64 may be reheated before the medium S is separated or while the medium S is being separated from the transport fixing belt 62.

In this example, the heat transfer instrument 100 is disposed closer to the cooling unit 64 than to the heating fixing roller 61.

### Configuration Example of Heat Transfer Instrument

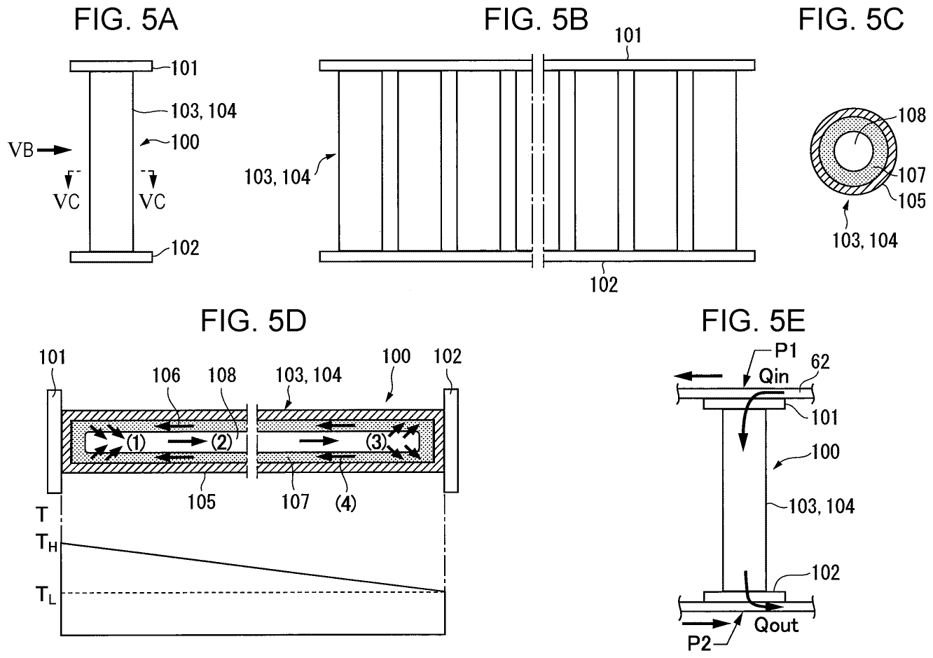

In this example, as illustrated in FIG. 5A, the heat transfer instrument 100 includes a first contact member 101, a second contact member 102, and a heat conducting component 103.

The first contact member 101 is disposed to contact the first position P1 on the back side of the transport fixing belt 62. The first contact member 101 is constituted by a metal plate made of a heat conducting material, such as aluminum, and extends in a direction intersecting with the moving direction of the transport fixing belt 62.

The second contact member 102 is disposed to contact the second position P2 on the back side of the transport fixing belt 62. The second contact member 102 is constituted by a metal plate made of a heat conducting material, such as aluminum, and extends in a direction intersecting with the moving direction of the transport fixing belt 62.

The heat conducting component 103 is bonded between the first contact member 101 and the second contact member 102. In this example, multiple heat conducting components 103 are provided in a direction intersecting with the transport direction of the medium S, as shown in FIG. 5B.

As the heat conducting component 103, a heat pipe 104, such as that shown in FIGS. 5C and 5D, is used. The heat pipe 104 includes a hollow (cylindrical, for example) pipe body 105 made of copper or aluminum having high conductivity. The pipe body 105 is sealed at both ends, and a highly volatile hydraulic fluid 106 is contained in the pipe body 105. A wick 107 is provided on the inner wall of the pipe body 105 while leaving a hollow portion 108 inside the pipe body 105. The wick 107 is constituted by a bundle of core members having a capillary structure and serves the function of moving the condensed hydraulic fluid 106 utilizing the capillary action.

In this example, when a temperature difference is generated across the pipe body 105, heat transfer occurs in the heat pipe 104 by the following process steps (1) through (4). In FIG. 5D, the temperature T of the high temperature portion is indicated by T_{H}, while the temperature T of the low temperature portion is indicated by T_{L.}
(1) The hydraulic fluid 106 absorbs heat and evaporates on the inner wall of the high temperature portion of the heat pipe 104.
(2) Vapor of the hydraulic fluid 106 is transferred to the low temperature portion via the hollow portion 108.
(3) Vapor of the hydraulic fluid 106 cooled in the low temperature portion condenses into a liquid and is absorbed into the wick 107 on the inner wall.
(4) The hydraulic fluid 106 returns to the high temperature portion via the wick 107 due to the capillary action.

In this manner, the hydraulic fluid 106 circulates inside the heat pipe 104, and heat transfer from the high temperature portion to the low temperature portion occurs.

In the first exemplary embodiment, as illustrated in FIG. 5E, the first position P1 of the transport fixing belt 62 is the high temperature portion, while the second position P2 thereof is the low temperature portion. In the heat transfer instrument 100, the first contact member 101 contacts the first position P1, which is the high temperature portion, while the second contact member 102 contacts the second position P2, which is the low temperature portion. In this state, part of heat Qin of the transport fixing belt 62 at the first position P1 is absorbed into the first contact member 101. This generates a temperature difference in which the first contact member 101 enters a higher temperature state, while the second contact member 102 enters a lower temperature state.

Heat Qin absorbed in the first contact member 101 is transmitted to the second contact member 102 in the low temperature state due to the heat conduction effect of the heat pipe 104, which is a heat conducting component. Then, heat Qin is transmitted to the low temperature portion (the second position P2) of the transport fixing belt 62 that contacts the second contact member 102 and is dissipated as heat Qout.

Through the above-described heat transfer process, at the first position P1 of the transport fixing belt 62, heat Qin is absorbed into the heat transfer instrument 100, and the transport fixing belt 62 is cooled accordingly.

At the second position P2 of the transport fixing belt 62, heat Qout is transferred from the heat transfer instrument 100 to the transport fixing belt 62, and the transport fixing belt 62 is heated accordingly.

The degree by which the transport fixing belt 62 is cooled or heated by the heat transfer instrument 100 is dependent on the heat conductivity of the heat transfer instrument 100. If it is desired to lower the temperature of the transport fixing belt 62 at the first position P1 by 5° or greater, for example, the heat conductivity of the heat transfer instrument 100 is determined to achieve this temperature drop.

### Peripheral Structure of Second Fixing Unit

In this example, as illustrated in FIG. 6, near the entrance of the second fixing unit 60, an entrance guiding member 52 is provided to guide the medium S into the entrance of the second fixing unit 60. A position sensor 53 is also provided to detect the position of the leading end or the trailing end of the medium S which is to pass through the transport path 51.

Near the exit of the second fixing unit 60, an exit guiding member 54 is provided to guide the medium S output from the exit of the second fixing unit 60. Transport rollers 55 are provided on the downstream side of the exit guiding member 54.

In this example, to obtain a high-gloss image, the separation temperature Ts of the medium S at the separation position of the second fixing unit 60 is adjusted to be a predetermined threshold temperature or lower. To adjust the temperature Ts of the medium S, a contactless temperature sensor 56 is disposed near the separation position of the second fixing unit 60 and measures the temperature Ts of the medium S at the separation position. As the temperature sensor 56, a radiation thermometer is used.

### Control System of Second Fixing Unit

In this example, as illustrated in FIG. 6, the control system of the second fixing unit 60 includes a control device 150 constituted by a microcomputer including various processors. The term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

An operation panel 151 of the image forming system 15 is connected to the control device 150. In the operation panel 151, a start switch (SW) for causing the control device 150 to start processing for forming an image on the medium S, a mode switch (SW) for selecting an image forming mode, such as single-sided printing, double-sided printing, or high-definition printing, and a medium type specifier for specifying a medium type to be used, for example, are provided.

In a read only memory (ROM), which serves as a storage of the control device 150, a program regarding fixing processing (such as heating and pressurizing processing in the fixing area FA and cooling processing by the cooling unit 64) executed by the second fixing unit 60 is preinstalled. Various detectors, such as the position sensor 53 and the temperature sensors 56 and 641, are connected to the control device 150. Various control targets, such as the drive motor 69 and the heat sources 65 and 66, are also connected to the control device 150.

The processor of the control device 150 receives an instruction signal from the operation panel 151 and detection signals from various detectors, executes the above-described program, and sends suitable control signals to the control targets.

### Basic Operation of Image Forming System

The basic operation of the image forming system 15 will now be described below.

As shown in FIG. 2, the individual colors of toner images formed by the image formers 20 (20a through 20d) are transferred onto the intermediate transfer body 30 in the first transfer operation and are transported to a second transfer region. The superimposed toner images held on the intermediate transfer body 30 are transferred together onto the medium S fed from the medium supply container 81 by the second transfer device 33 in the second transfer operation.

The unfixed toner images transferred onto the medium S together are fixed by the first fixing unit 40. Then, the medium S having the fixed toner image thereon is guided to the first output receiver 87 or to the second output receiver 88 via the postprocessing device 50 by the switching member 86.

In the first exemplary embodiment, the switching member 86 switches the medium transport direction in the following manner. The switching member 86 switches the medium transport direction in accordance with whether the plain paper print mode or the photograph print mode is used. The plain paper print mode is a mode in which a regular image, that is, a low-gloss print sheet, is formed. The photograph print mode is a mode in which a high-gloss image, such as a photographic image, that is, a high-gloss print sheet, is formed.

In the plain paper print mode, the medium S subjected to the fixing operation by the first fixing unit 40 is output to the first output receiver 87 by the switching member 86. In the photograph print mode, the medium S subjected to the fixing operation by the first fixing unit 40 is output to the second fixing unit 60 by the switching member 86. Then, the medium S is subjected to the fixing operation by the second fixing unit 60 and is output to the second output receiver 88 via the cutting device 70. The cutting device 70 can be used when a borderless print sheet, such as a photographic image, is to be output, for example. If it is not necessary to cut the medium S, the medium S is simply output to the second output receiver 88 without using the cutting device 70.

Typically, to obtain a high-gloss image, such as a photographic image, a special sheet, such as that shown in FIG. 4A, may be used as the medium S.

In the photograph print mode, when the second fixing unit 60 performs a fixing operation using such a special sheet, the resulting toner image is embedded into the image receiving layer L3, as shown in FIG. 4B. At this time, the surface texture of the transport fixing belt 62 of the second fixing unit 60 is reflected, which makes the surface of the image receiving layer L3 and the surface of the toner image substantially uniform, resulting in a high-gloss image.

### Fixing Operation of Second Fixing Unit

The fixing operation of the second fixing unit 60 is performed as follows.

The medium S guided to the postprocessing device 50 via the first fixing unit 40 is about to enter the second fixing unit 60, as shown in FIG. 3A. In this state, in the second fixing unit 60, the heating fixing roller 61 and the pressurizing fixing roller 63 are respectively heated by the heat sources 65 and 66 to the temperatures at which they can fix a toner image onto the medium S. The transport fixing belt 62 is rotating in accordance with the rotation of the heating fixing roller 61.

The cooling unit 64 is in a standby state to perform a cooling operation by driving the air blower.

In this state, the medium S is heated and pressurized in the fixing area FA and is then transported by the transport fixing belt 62. Then, the heated medium S is cooled by the cooling unit 64 and is then separated at the separation position of the second fixing unit 60.

In this manner, the medium S undergoes a series of fixing processing, that is, heating and pressurizing processing and then cooling processing, in the second fixing unit 60. As a result, with the use of a special sheet, such as that shown in FIG. 4A, a high-gloss image, such as a photographic image, can be obtained.

### Operation of Heat Transfer Instrument

### Heat Dissipation From Transport Fixing Belt

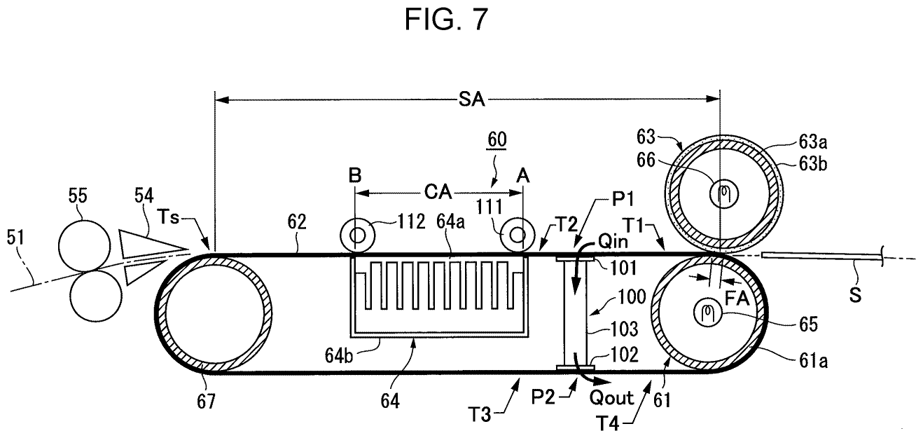

In this example, the transport fixing belt 62 is subjected to heat transfer processing by the heat transfer instrument 100 before being cooled by the cooling unit 64. As illustrated in FIG. 7, the heat transfer instrument 100 absorbs heat Qin at the first position P1 of the transport fixing belt 62 and transfers it to the second position P2. When the transport fixing belt 62 is passing through the first position P1, heat Qin is taken away from the transport fixing belt 62 by the heat transfer instrument 100. It is now assumed that the temperature of the transport fixing belt 62 before the first position P1 is indicated by T1 and that after the first position P1 is indicated by T2. In this case, T2<T1 holds true. The transport fixing belt 62 whose temperature is lowered by an amount equal to a temperature difference ΔT(T1−T2) enters the cooling area CA of the cooling unit 64. The cooling unit 64 requires the amount of energy to reduce the temperature of the medium S which has passed through the cooling area CA to a target temperature.

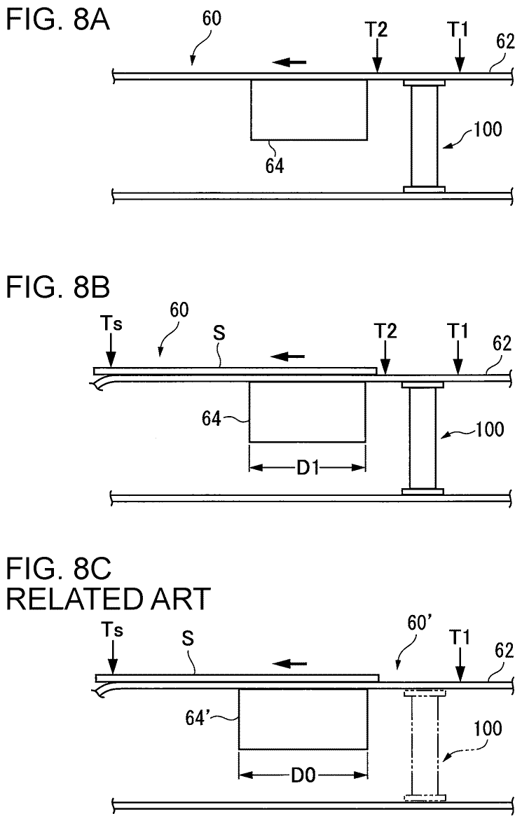

The cooling unit 64 of this example illustrated in FIG. 8B is now compared with a cooling unit 64′of a second fixing unit 60′of a first comparative example illustrated in FIG. 8C in terms of the cooling capacity. As shown in FIG. 8B, the cooling unit 64 of this example requires the cooling capacity to lower the temperature of the medium S held on the transport fixing belt 62 having the temperature T2 to a predetermined temperature. In contrast, the cooling unit 64′of the first comparative example requires the cooling capacity to lower the temperature of the medium S held on the transport fixing belt 62 having the temperature T1(T1>T2) to the predetermined temperature. The cooling capacity of the cooling unit 64 and that of the cooling unit 64′are determined so that the separation temperature Ts of the medium S at the separation position becomes lower than or equal to the predetermined threshold temperature Tth to obtain a high-gloss image.

The cooling unit 64 of this example requires a lower level of the cooling capacity than the cooling unit 64′of the first comparative example.

In this example, the cooling capacity of the cooling unit 64 is dependent on the contact area between the transport fixing belt 62 and the cooling unit 64 or on the air volume of the air blower.

The contact area between the transport fixing belt 62 and the cooling unit 64 will first be examined.

The length of the transport fixing belt 62 in its moving direction which contacts the cooling unit 64′of the first comparative example is indicated by D0, while the length of the transport fixing belt 62 which contacts the cooling unit 64 of this example is indicated by D1.

The contact area of the cooling unit 64 of the example with the transport fixing belt 62 can be made smaller than that of the cooling unit 64′of the first comparative example with the transport fixing belt 62. Hence, D0>D1 holds true.

The contact length D1 of the cooling unit 64 of the example can be made smaller than the contact length D0 of the cooling unit 64′of the first comparative example. The size of the cooling unit 64 of the example along the moving direction of the transport fixing belt 62 can thus be reduced. This makes it possible to design a smaller medium transport area SA of the transport fixing belt 62, resulting in a reduced size of the second fixing unit 60. This will be discussed in detail later when referring to first and second examples of the second fixing unit 60.

Regarding the air volume of the air blower, which is not shown, the air volume of the cooling unit 64 of the example can be reduced compared with that of the cooling unit 64′of the first comparative example. This can lower driving power of the air blower of the cooling unit 64 of the example.

### Heat Dissipation to Transport Fixing Belt

As illustrated in FIG. 7, the heat transfer instrument 100 transfers heat Qin absorbed from the transport fixing belt 62 at the first position P1 and emits it to the transport fixing belt 62 at the second position P2 as heat Qout. When the transport fixing belt 62 is passing through the second position P2, it receives heat Qout from the heat transfer instrument 100. It is now assumed that the temperature of the transport fixing belt 62 before the second position P2 is indicated by T3 and that after the second position P2 is indicated by T4. In this case, T3<T4 holds true. The transport fixing belt 62 whose temperature is raised by an amount equal to a temperature difference ΔT(T4−T3) enters the heating area of the heating fixing roller 61. In the heating fixing roller 61, heating power is supplied to the heat source 65 to raise the temperature of the fixing area FA at which a toner image can be fixed on a medium. In this example, heating power is also supplied to the heat source 66 of the pressurizing fixing roller 63.

The heating fixing roller 61 requires heating energy to raise the temperature T4 of the transport fixing belt 62 to a temperature at which a toner image can be fixed on a medium. In contrast, the heating fixing roller (not shown) of the first comparative example requires heating energy to raise the temperature T3(T3<T4) of the transport fixing belt 62 to the temperature at which a toner image can be fixed on a medium. The heating fixing roller 61 of this example thus requires a smaller amount of heating energy than the heating fixing roller (not shown) of the first comparative example.

### Distinctive Layout of Heat Transfer Instrument

In this example, the heat transfer instrument 100 within the space surrounded by the transport fixing belt 62 is disposed closer to the cooling unit 64 than to the heating fixing roller 61. The heat transfer instrument 100 is thus less vulnerable to heat from the heating fixing roller 61 than when it is disposed closer to the heating fixing roller 61. If the heat transfer instrument 100 is disposed closer to the heating fixing roller 61, the central portion of the heat transfer instrument 100 in the longitudinal direction becomes close to the heating fixing roller 61 and is thus likely to be heated. The central portion of the heat pipe 104, which serves as the heat conducting component 103, is partially heated, which may impair the mobility of the hydraulic fluid 106 inside the heat pipe 104. In this example, heat transfer from the heating fixing roller 61 is mostly performed through radiation, and an electromagnetic wave is radially emitted. With a sufficient distance between the heat pipe 104 and the heating fixing roller 61, the amount of heat radiation applied to the heat pipe 104 may be decreased.

### Second Exemplary Embodiment

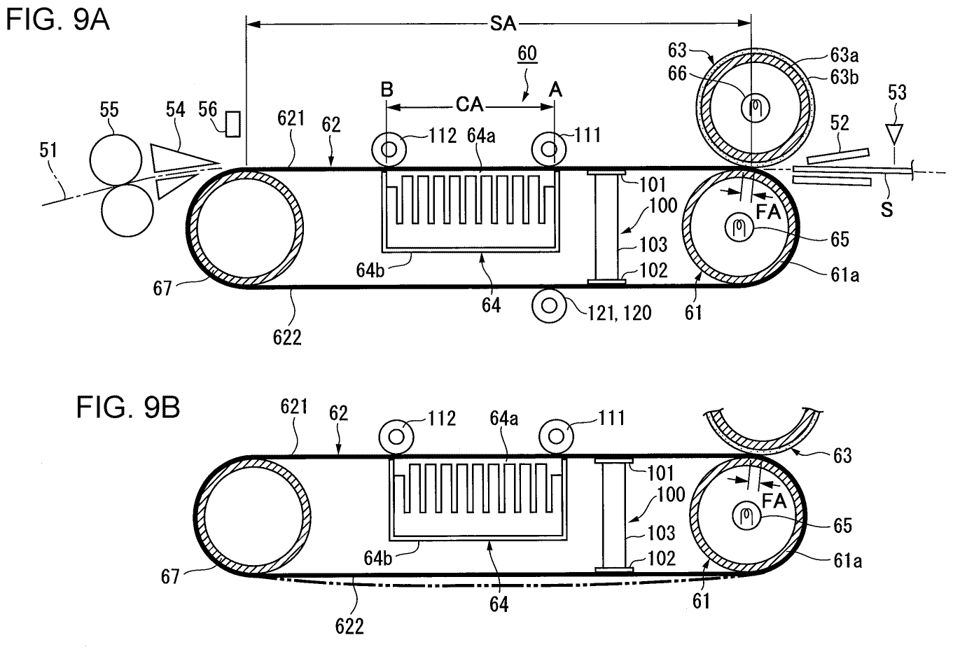

FIG. 9A illustrates the major part of a second fixing unit 60 according to a second exemplary embodiment.

In FIG. 9A, the basic configuration of the second fixing unit 60 is similar to that of the first exemplary embodiment. However, unlike the first exemplary embodiment, the second fixing unit 60 includes a holding member 120 that holds the contact state between the heat transfer instrument 100 and the transport fixing belt 62. Elements similar to those of the first exemplary embodiment are designated by like reference numerals and a detailed explanation thereof will be omitted.

In this example, the first position P1 of the transport fixing belt 62 is located at a higher position than the second position P2. An upper belt portion 621 of the transport fixing belt 62 in the medium transport area SA is partially brought into contact with the cooling unit 64. The position of the surface of the upper belt portion 621 of the transport fixing belt 62 is thus determined in a region between the heating fixing roller 61 and the cooling unit 64. As a result, the transport fixing belt 62 can stably contact the first contact member 101 of the heat transfer instrument 100 at the first position P1.

In contrast, a lower belt portion 622 of the transport fixing belt 62 in a direction in which the transport fixing belt 62 is returning to the heating fixing roller 61 does not have any member to support it. The distance of the lower belt portion 622 from the separating roller 67 to the heat transfer instrument 100 is long, as shown in FIG. 9B. The transport fixing belt 62 is thus likely to flutter at the second position P2, and the contact state of the transport fixing belt 62 with the second contact member 102 of the heat transfer instrument 100 is likely to become unstable.

To address this issue, in this example, the above-described holding member 120 is provided under the lower belt portion 622 of the transport fixing belt 62, as shown in FIG. 9A. The holding member 120 is disposed farther upstream than the second position P2 in the moving direction of the transport fixing belt 62 while contacting the lower belt portion 622. In this example, the holding member 120 includes a holding roller 121 that is rotated by following the movement of the transport fixing belt 62. The holding roller 121 serves as a positioning roller that determines the position of the lower belt portion 622 from under the lower belt portion 622. The position of the surface of the lower belt portion 622 of the transport fixing belt 62 is thus determined in a region between the heating fixing roller 61 and the holding roller 121. As a result, the transport fixing belt 62 can stably contact the second contact member 102 of the heat transfer instrument 100 at the second position P2.

Additionally, in this example, the inlet opposing roller 111 is provided on the upper belt portion 621 of the transport fixing belt 62 so as to oppose the inlet of the cooling area CA of the cooling unit 64. The inlet opposing roller 111 is rotated by following the movement of the transport fixing belt 62 so as to guide the medium S to the cooling area CA. The inlet opposing roller 111 also serves as a positioning roller that determines the position of the upper belt portion 621 of the transport fixing belt 62 from above the upper belt portion 621. It is thus likely to prevent the upper belt portion 621 from being elevated while the transport fixing belt 62 is moving. In this manner, the inlet opposing roller 111 can also serve as a holding member 120 that holds the contact state of the transport fixing belt 62 with the first contact member 101 of the heat transfer instrument 100 at the first position P1.

### Modified Example of Second Exemplary Embodiment

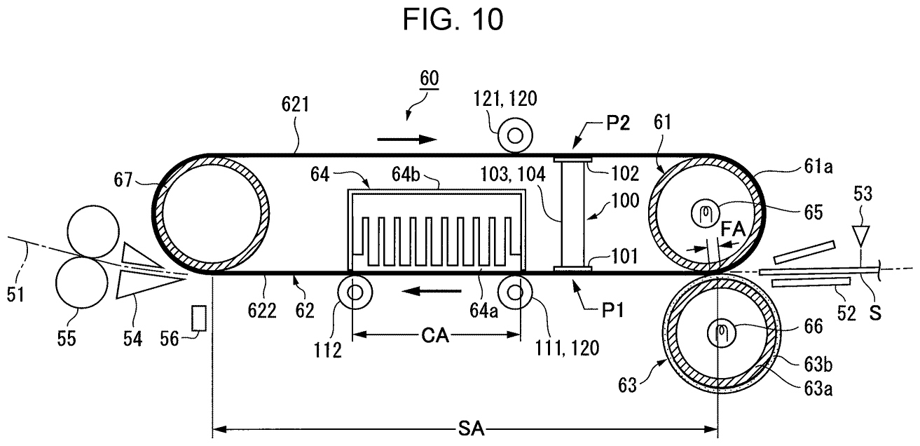

FIG. 10 illustrates the major part of a second fixing unit 60 according to a modified example of the second exemplary embodiment.

In FIG. 10, the basic configuration of the second fixing unit 60 is similar to that of the second exemplary embodiment. The second fixing unit 60 of the modified example is a unit obtained by vertically inverting the top side and the bottom side of the second fixing unit 60 of the second exemplary embodiment.

As in the second exemplary embodiment, in the second fixing unit 60 of the modified example, the transport fixing belt 62 is tightly stretched between the heating fixing roller 61 and the separating roller 67. Unlike the second exemplary embodiment, however, the transport fixing belt 62 is rotated clockwise. In the modified example, the lower belt portion 622 of the transport fixing belt 62 serves as the medium transport area SA.

Hence, the cooling unit 64 is disposed to contact part of the lower belt portion 622 of the transport fixing belt 62.

In the modified example, the first position P1 (high temperature portion) of the transport fixing belt 62 is located at a lower position than the second position P2 (low temperature portion). In the heat transfer instrument 100, the high temperature portion of the heat pipe 104, which is the heat conducting component 103, is positioned on the bottom side in the vertical direction. Disposing the heat pipe 104 in this manner facilitates the movement of a hydraulic fluid within the heat pipe 104.

Additionally, in the modified example, the inlet opposing roller 111 is provided on the front side of the transport fixing belt 62 at a portion corresponding to the inlet of the cooling area CA of the cooling unit 64. The outlet opposing roller 112 is provided on the front side of the transport fixing belt 62 at a portion corresponding to the outlet of the cooling area CA of the cooling unit 64.

In the modified example, the inlet opposing roller 111 also serves as a holding member 120 that holds the contact state of the transport fixing belt 62 with the first contact member 101 of the heat transfer instrument 100. More specifically, the inlet opposing roller 111 is disposed farther downstream than the first position P1 in the moving direction of the transport fixing belt 62 while contacting the lower belt portion 622 of the transport fixing belt 62. The inlet opposing roller 111 thus serves as a positioning roller that determines the position of the lower belt portion 622 from under the lower belt portion 622. The position of the surface of the lower belt portion 622 of the transport fixing belt 62 is thus determined in a region between the heating fixing roller 61 and the inlet opposing roller 111. As a result, the transport fixing belt 62 can stably contact the first contact member 101 of the heat transfer instrument 100 at the first position P1.

In contrast, the upper belt portion 621 of the transport fixing belt 62 does not have any member to support it. The distance of the upper belt portion 621 from the separating roller 67 to the heat transfer instrument 100 is thus long. The transport fixing belt 62 is thus likely to flutter at the second position P2, and the contact state of the transport fixing belt 62 with the second contact member 102 of the heat transfer instrument 100 is likely to become unstable.

To address this issue, in the modified example, a holding member 120 is provided above the upper belt portion 621 of the transport fixing belt 62, as shown in FIG. 10. The holding member 120 is disposed farther upstream than the second position P2 in the moving direction of the transport fixing belt 62 while contacting the upper belt portion 621. In the modified example, the holding member 120 includes a holding roller 121 which is rotated by following the movement of the transport fixing belt 62. The holding roller 121 serves as a positioning roller that determines the position of the upper belt portion 621 from above the upper belt portion 621. The position of the surface of the upper belt portion 621 of the transport fixing belt 62 is thus determined in a region between the heating fixing roller 61 and the holding roller 121. As a result, the transport fixing belt 62 can stably contact the second contact member 102 of the heat transfer instrument 100 at the second position P2.

### First Example

In a first example, the second fixing unit of the first exemplary embodiment is realized, and the relationship between the separation temperature of a medium and the gloss of a medium image is examined.

In the first example, the fixing conditions used by the second fixing unit are as follows.
Medium: special sheet for photographic images (see FIG. 4A)
Toner: toners of four colors (yellow, magenta, cyan, and black)
Fixing temperature: 140° C.
Medium transport speed of transport fixing belt: 50 mm/s
Heat transfer instrument: heat pipe
Cooling capacity of cooling unit: variable
Temperature measurement: using a radiation thermometer as a temperature sensor

In the first example, the fixing conditions for the fixing area FA are not varied, and cooling capacity (air volume) of the cooling unit is varied to change the separation temperature of the medium.

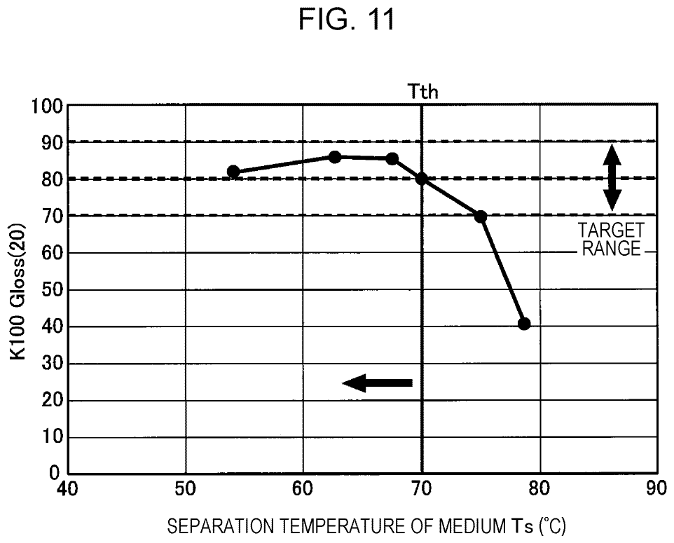

FIG. 11 is a graph illustrating the results of examining the relationship between the separation temperature of a medium and the gloss of a medium image.

In FIG. 11, the horizontal axis indicates the separation temperature Ts (° C.) of the medium at the separation position of the second fixing unit, while the vertical axis indicates the specular gloss, which is represented by K100 Gloss (20). The specular gloss is obtained by measuring a patch image made of 100% black (K) toner at an inclination angle of 20°.

It is seen from FIG. 11 that, to achieve a gloss unit of 80% or higher of the medium image, in other words, to obtain a high-gloss image, the fixing conditions are adjusted so that the separation temperature Ts of the medium becomes lower than or equal to a certain threshold temperature Tth (70° C., for example).

### Second Example

In a second example, the second fixing unit of the first exemplary embodiment is realized, and the effect of reducing the energy dissipated by the cooling unit by the provision of a heat transfer instrument is examined.

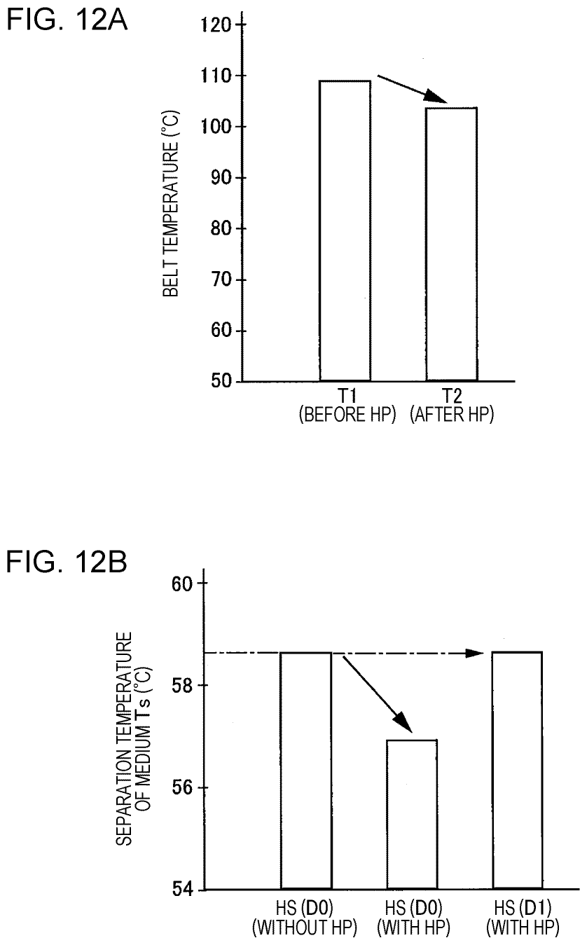

In the second example, the temperature T1 of the transport fixing belt 62 at a position before the heat transfer instrument 100 and the temperature T2 of the transport fixing belt 62 at a position after the heat transfer instrument 100 are measured, as shown in FIGS. 8A and 8B, and the result shown in FIG. 12A is obtained.

In FIG. 12A, on the horizontal axis, T1 (before HP) represents the temperature of the transport fixing belt 62 that has not yet passed through the heat transfer instrument 100, while T2 (after HP) represents the temperature of the transport fixing belt 62 that has passed through the heat transfer instrument 100. The belt temperature on the vertical axis represents the temperature of the transport fixing belt 62.

FIG. 12A shows that the heat transfer instrument 100 (HP) successfully lowers the temperature of the transport fixing belt 62 from 109° C. to 104° C. by 5° C. However, the effect of lowering the temperature of the medium is not particularly observed.

Obtaining a suitable separation temperature of a medium by the second example and that by a comparative example without a heat transfer instrument are examined.

The examination results are shown in FIG. 12B.

In FIG. 12B, on the horizonal axis, “HS(D0)/without HP” represents a mode (case 1) in which the length of the cooling unit (HS) in the cooling area CA in the medium transport direction in the comparative example is D0; “HS(D0)/with HP” represents a mode (case 2) in which the length of the cooling unit (HS) in the cooling area CA in the medium transport direction in the second example is D0; and “HS(D1)/with HP” represents a mode (case 3) in which the length of the cooling unit (HS) in the cooling area CA in the medium transport direction in the second example is D1(D1<D0). In FIG. 12B, the vertical axis indicates the separation temperature Ts of the medium.

It is understood from the first example that, to obtain a high-gloss image, the separation temperature Ts of the medium is set to be lower than or equal to a certain threshold temperature Tth (70° C., for example).

In terms of this result, in the comparative example (case 1), the fixing conditions are determined so that the separation temperature Ts of the medium becomes 58.5° C., for example.

In the second example (case 2), the separation temperature Ts of the medium becomes 56.8° C. At this temperature, the length D0 is 39 mm.

In the second example (case 3), the length D1 of the cooling unit is adjusted so that the separation temperature Ts of the medium substantially becomes equal to that of case 1. When the separation temperature Ts of the medium is 58.4° C., the length D1 is 36 mm.

It is understood from the second example described above that the energy dissipated by a cooling unit can be reduced with the provision of a heat transfer instrument, compared with a cooling unit without a heat transfer instrument. For example, with substantially the same separation temperature Ts of the medium, the length of the cooling unit in the medium transport direction in the second example can be decreased from D0 to D1 by about 8%. This can further reduce the size of the second fixing unit.

To reduce the energy dissipated by a cooling unit, the air volume of the cooling unit can be decreased instead of reducing the size of the cooling unit.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A fixing device comprising:
a heating fixing unit that is rotatable and includes a heat source;
a belt-like transport fixing unit that is rotatably provided as a result of being tightly stretched on the heating fixing unit and that transports a medium having an unfixed image formed thereon while contacting a surface of the medium on which the unfixed image is formed;
a pressurizing fixing unit that is rotatable and is disposed to face the heating fixing unit so as to sandwich the transport fixing unit therebetween and that applies pressure so as to form a fixing area between the pressurizing fixing unit and the heating fixing unit, the fixing area being an area where the unfixed image is fixed;
a cooling unit that cools the transport fixing unit, the cooling unit being disposed in a transport region of the transport fixing unit for the medium so as to contact a back side of the transport fixing unit, the cooling unit being disposed at a position farther downstream than the fixing area in a transport direction of the medium; and
a heat transfer unit that is disposed in an internal space on the back side of the transport fixing unit and is positioned between the cooling unit and the heating fixing unit without contacting the cooling unit and the heating fixing unit and that contacts a first position and a second position and transfers part of heat of the transport fixing unit from the first position to the second position, the first position being located in a region where the transport fixing unit is heated and is not yet cooled, the second position being located in a region where the transport fixing unit is cooled and is not yet heated.
(((2)))

The fixing device according to (((1))), wherein the heat transfer unit includes a heat conducting component that conducts heat from a high temperature portion to a low temperature portion.
(((3)))

The fixing device according to (((2))), wherein the heat transfer unit includes
a first contact member that is disposed to contact the first position on the back side of the transport fixing unit and that is made of a heat conducting material and extends in a direction intersecting with a moving direction of the transport fixing unit,
a second contact member that is disposed to contact the second position on the back side of the transport fixing unit and that is made of a heat conducting material and extends in the direction intersecting with the moving direction of the transport fixing unit, and
the heat conducting component that is bonded between the first contact member and the second contact member.
(((4)))

The fixing device according to (((2))) or (((3))), wherein a plurality of the heat conducting components are disposed at an interval therebetween in a direction intersecting with the transport direction of the medium.
(((5)))

The fixing device according to one of (((2))) to (((4))), wherein the heat conducting component is a heat pipe.
(((6)))

The fixing device according to one of (((1))) to (((5))), wherein the heat transfer unit is disposed closer to the cooling unit than to the heating fixing unit.
(((7)))

The fixing device according to one of (((1))) to (((6))), further comprising:
a holding unit that holds a contact state between the heat transfer unit and the transport fixing unit.
(((8)))

The fixing device according to (((7))), wherein the holding unit is a positioning unit that is disposed farther upstream than the second position of the transport fixing unit in a moving direction of the transport fixing unit and that determines a position of the transport fixing unit so as to allow the heat transfer unit to maintain a contact state with the second position.
(((9)))

The fixing device according to (((7))), further comprising:
an opposing rotator that is disposed to oppose an inlet of a cooling area of the cooling unit with the transport fixing unit interposed therebetween and that is rotated by following movement of the transport fixing belt,
wherein the holding unit also serves as the opposing rotator and allows the heat transfer unit to maintain a contact state with the first position.
(((10)))

The fixing device according to one of (((1))) to (((9))), wherein the heat transfer unit has a heat conductivity that allows a temperature of the transport fixing unit, which is about to enter a cooling area of the cooling unit, at the first position to be lowered by 5° C. or greater.
(((11)))

The fixing device according to (((10))), wherein the heat conductivity of the heat transfer unit allows a temperature of the medium at a separation position at which the medium is separated from the transport fixing unit to become lower than or equal to a threshold temperature, the threshold temperature being a temperature of the medium required to obtain a high-gloss fixed image, the heat conductivity of the heat transfer unit being determined based on a heating amount of the heating fixing unit and a heat dissipation amount of the cooling unit.
(((12)))

An image forming system comprising:
an image forming unit that forms an unfixed image on a medium; and
the fixing device according to one of (((1))) to (((11))) that fixes the unfixed image formed on the medium onto the medium.

What is claimed is:

1. A fixing device comprising:
a heating fixing unit that is rotatable and includes a heat source;
a belt-like transport fixing unit that is rotatably provided as a result of being tightly stretched on the heating fixing unit and that transports a medium having an unfixed image formed thereon while contacting a surface of the medium on which the unfixed image is formed;
a pressurizing fixing unit that is rotatable and is disposed to face the heating fixing unit so as to sandwich the transport fixing unit therebetween and that applies pressure so as to form a fixing area between the pressurizing fixing unit and the heating fixing unit, the fixing area being an area where the unfixed image is fixed;
a cooling unit that cools the transport fixing unit, the cooling unit being disposed in a transport region of the transport fixing unit for the medium so as to contact a back side of the transport fixing unit, the cooling unit being disposed at a position farther downstream than the fixing area in a transport direction of the medium; and
a heat transfer unit that is disposed in an internal space on the back side of the transport fixing unit and is positioned between the cooling unit and the heating fixing unit without contacting the cooling unit and the heating fixing unit and that contacts a first position and a second position and transfers part of heat of the transport fixing unit from the first position to the second position, the first position being located in a region where the transport fixing unit is heated and is not yet cooled, the second position being located in a region where the transport fixing unit is cooled and is not yet heated.

2. The fixing device according to claim 1, wherein the heat transfer unit includes a heat conducting component that conducts heat from a high temperature portion to a low temperature portion.

3. The fixing device according to claim 2, wherein the heat transfer unit includes
a first contact member that is disposed to contact the first position on the back side of the transport fixing unit and that is made of a heat conducting material and extends in a direction intersecting with a moving direction of the transport fixing unit,
a second contact member that is disposed to contact the second position on the back side of the transport fixing unit and that is made of a heat conducting material and extends in the direction intersecting with the moving direction of the transport fixing unit, and
the heat conducting component that is bonded between the first contact member and the second contact member.

4. The fixing device according to claim 2, wherein a plurality of the heat conducting components are disposed at an interval therebetween in a direction intersecting with the transport direction of the medium.

5. The fixing device according to claim 2, wherein the heat conducting component is a heat pipe.

6. The fixing device according to claim 1, wherein the heat transfer unit is disposed closer to the cooling unit than to the heating fixing unit.

7. The fixing device according to claim 1, further comprising:
a holding unit that holds a contact state between the heat transfer unit and the transport fixing unit.

8. The fixing device according to claim 7, wherein the holding unit is a positioning unit that is disposed farther upstream than the second position of the transport fixing unit in a moving direction of the transport fixing unit and that determines a position of the transport fixing unit so as to allow the heat transfer unit to maintain a contact state with the second position.

9. The fixing device according to claim 7, further comprising:
an opposing rotator that is disposed to oppose an inlet of a cooling area of the cooling unit with the transport fixing unit interposed therebetween and that is rotated by following movement of the transport fixing belt,
wherein the holding unit also serves as the opposing rotator and allows the heat transfer unit to maintain a contact state with the first position.

10. The fixing device according to claim 1, wherein the heat transfer unit has a heat conductivity that allows a temperature of the transport fixing unit, which is about to enter a cooling area of the cooling unit, at the first position to be lowered by 5° C. or greater.

11. The fixing device according to claim 10, wherein the heat conductivity of the heat transfer unit allows a temperature of the medium at a separation position at which the medium is separated from the transport fixing unit to become lower than or equal to a threshold temperature, the threshold temperature being a temperature of the medium required to obtain a high-gloss fixed image, the heat conductivity of the heat transfer unit being determined based on a heating amount of the heating fixing unit and a heat dissipation amount of the cooling unit.

12. An image forming system comprising:
an image forming unit that forms an unfixed image on a medium; and
the fixing device according to claim 1 that fixes the unfixed image formed on the medium onto the medium.

13. An image forming system comprising:
an image forming unit that forms an unfixed image on a medium; and
the fixing device according to claim 2 that fixes the unfixed image formed on the medium onto the medium.

14. An image forming system comprising:
an image forming unit that forms an unfixed image on a medium; and
the fixing device according to claim 3 that fixes the unfixed image formed on the medium onto the medium.

15. An image forming system comprising:
an image forming unit that forms an unfixed image on a medium; and
the fixing device according to claim 4 that fixes the unfixed image formed on the medium onto the medium.

16. An image forming system comprising:
an image forming unit that forms an unfixed image on a medium; and
the fixing device according to claim 5 that fixes the unfixed image formed on the medium onto the medium.

17. An image forming system comprising:
an image forming unit that forms an unfixed image on a medium; and
the fixing device according to claim 6 that fixes the unfixed image formed on the medium onto the medium.

18. An image forming system comprising:
an image forming unit that forms an unfixed image on a medium; and
the fixing device according to claim 7 that fixes the unfixed image formed on the medium onto the medium.

19. An image forming system comprising:
an image forming unit that forms an unfixed image on a medium; and
the fixing device according to claim 8 that fixes the unfixed image formed on the medium onto the medium.

20. An image forming system comprising:
an image forming unit that forms an unfixed image on a medium; and
the fixing device according to claim 9 that fixes the unfixed image formed on the medium onto the medium.
